(19) United States
(12) Patent Application Publication
(10) Pub. No.: US 2020/0044393 A1
(43) Pub. Date: Feb. 6, 2020

(54) LIGHT GUIDE COMPONENT, PLUG, AND ADAPTER

(71) Applicant: NEC Platforms, Ltd., Kawasaki-shi, Kanagawa (JP)

(72) Inventor: Hiroshi NISHIKAWA, Kanagawa (JP)

(73) Assignee: NEC Platforms, Ltd., Kawasaki-shi, Kanagawa (JP)

(21) Appl. No.: 16/338,536

(22) PCT Filed: Oct. 4, 2017
(86) PCT No.: PCT/JP2017/036062

§ 371 Date: Apr. 1, 2019

(30) Foreign Application Priority Data
Oct. 6, 2016 (JP) 2016-198130

(51) Int. Cl. H01R 13/641; F21V 8/00; H01R 13/717

(52) U.S. Cl. CPC H01R 13/641; H01R 13/717; G02B 6/0008

(57) ABSTRACT

A plug (102) for connection with a receptacle (200) via a front face thereof on which a display lamp (210, 211) is formed. The plug (102) is provided with a light guide unit (112, 113) with one end for the entry of light from the display lamp (210, 211), wherein the input light is guided to a position or in a direction that is unlikely to be blocked by the plug (102) connected to the receptacle (200) or by a cable connected to the plug (102) connected to the receptacle (200), and then output from the other end. In this way, the visibility of the display lamp (210, 211) with the plug (102) connected to the receptacle (200) is improved.

### TECHNICAL FIELD

The present invention relates to a technology which improves visibility of a lamp of a receptacle, for displaying states when a plug is connected to the receptacle.

### BACKGROUND ART

In a connector for Ethernet (Registered trademark), etc., a receptacle may include a lamp for displaying states (display lamp) which displays states of an interface, etc.

PTL1 discloses an example of a receptacle with display lamps. An optical transmission device of PTL1 includes light emitting elements, an optical transmitter-receiver, a circuit board, and light guides. The light emitting element displays states of transmission and reception of an optical signal. The optical transmitter-receiver includes insertion openings to which connecters for the optical signals are inserted. The light emitting elements and the optical transmitter-receiver are mounted on the circuit board. The light guide guides a light from the light emitting element for display to a side of the insertion opening in a housing. As a result of the structure above described, in the optical transmission device of PTL1, the light emitting elements for display can be densely mounted with good visibility at low cost, and can be mounted with a reduced space in a direction of the height.

PTL2 discloses another example of a receptacle with display lamps. A connector of PTL2 includes indication lamps and a connector body. The indication lamp includes a light emitting unit and a light guide structure. The light guide structure includes a hollow structural body, and guides a light emitted from the light emitting unit to one end away from the light emitting unit. The connector body includes a housing space, which holds at least a part of the light guide structure therein. As a result of the structure above described, in the connector of PTL2, electromagnetic interference does not occur between the connector and combined electronic components and between the indication lamp and the components.

An example of a common connector for Ethernet having a receptacle with display lamps is explained. FIG. 12 and FIG. 13 are perspective views illustrating one example of the receptacle which is integrally formed with the display lamps, and a plug. FIG. 12 illustrates a state that the plug is not inserted to the receptacle yet. FIG. 13 illustrates a state that the plug is inserted to the receptacle.

Display lamps 210, 211 of receptacle 200 are likely to be blocked by plug 400 or a cable connected to plug 400, when plug 400 is inserted to receptacle 200. Visibility of display lamps 210, 211 is poor in directions (direction of a side face of receptacle 200 or a top face thereof) except for a direction of the front face of receptacle 200. Therefore, display lamps 210, 211 of receptacle 200 have a problem that the visibility is poor when plug 400 is inserted to receptacle 200.

Visibility may be improved by arranging the display lamps in an angle between the front face and the top face of the device. The arrangement, however, has a problem that there is no appropriate position on which the display lamps are arranged or a problem that it is difficult to visually confirm which receptacle's state is indicated by one of the display lamps if a plurality of receptacles are arranged.

PTL3 discloses an example of a technology that a plug has a display lamp. In a car adaptor of PTL3, visibility of the display lamp is improved by arranging the display lamp on the plug side.

The technology of PTL3, however, has a problem that the technology is applied only to plugs of an interface including a power source terminal.

PTL4 discloses an example of a technology that a display lamp lights up a plug. A display device of PTL4 includes a light source, a socket, and a light conductor. The light source indicates a status of an electronic device, and is placed inside the electronic device. The socket is connected to the semitransparent plug. The light conductor is optically connected to the light source at a first end, guides a light from the first end to a second end, and lights up the socket by the guided light when the plug is connected to the socket. As a result of the structure above described, in the display device of PTL4, since the semitransparent plug can be lighted up in the electronic device, a function of visually indicating a status of the electronic device is improved.

### CITATION LIST

### Patent Literature

[PTL 1] Japanese Unexamined Patent Application Publication No. 2004-70241
[PTL 2] Japanese Unexamined Patent Application Publication No. 2007-184265
[PTL 3] Japanese Unexamined Utility Model Application Publication No. H4-072581
[PTL 4] Japanese Unexamined Patent Application Publication (Translation of PCT Application) No. 2002-525828

### SUMMARY OF INVENTION

### Technical Problem

The technology of PTL4, however, has a problem that it is not applicable, as it is, to the receptacle that the display lamp is on the front face, such as a receptacle for Ethernet.

In view of the above problem, an object of the invention is to improve visibility of a display lamp when a plug is connected to a receptacle that the display lamp is on the front face of the receptacle.

### Solution to Problem

In one aspect of the invention, a light guide component is a light guide component which is arranged on a plug for connection with a receptacle via a front face thereof on which a display lamp is formed, wherein the light guide component inputs a light from the display lamp, guides the input light to a position or in a direction which is unlikely to be blocked by the plug connected to the receptacle or by a cable connected to the plug connected to the receptacle, and outputs the guided light from the other end.

In one aspect of the invention, a plug is a plug for connection with a receptacle via a front face thereof on which a display lamp is formed, including a light guide unit inputting a light from the display lamp, guiding the input light to a position or in a direction which is unlikely to be blocked by the plug connected to the receptacle or by a cable connected to the plug connected to the receptacle, and outputting the guided light from the other end.

In one aspect of the invention, an adapter including: a plug for connection with a first receptacle via a front face thereof on which a display lamp is formed; and a second receptacle electrically connected to the plug in a direction opposite to a direction of the connection with the first receptacle, wherein the plug includes a light guide unit inputting a light from the display lamp, guiding the input light to a position or in a direction which is unlikely to be blocked by the plug connected to the first receptacle or by a cable connected to the plug connected to the first receptacle, and outputting the guided light from the other end.

### Advantageous Effects of Invention

In the present invention, there is an effect that visibility of a display lamp when a plug is connected to a receptacle via a front face thereof on which a display lamp is formed is improved.

### BRIEF DESCRIPTION OF DRAWINGS

FIG. 1 is a perspective view illustrating an example of a structure of a plug of a first example embodiment of the invention.

FIG. 2 is a diagram explaining an operation of the plug of the first example embodiment of the invention.

FIG. 3 is a top view illustrating an example of a structure of a modified example of the first example embodiment of the invention.

FIG. 4 is a perspective view illustrating an example of a structure of a plug of a second example embodiment of the invention.

FIG. 5 is a diagram explaining an operation of the plug of the second example embodiment of the invention.

FIG. 6 is a perspective view illustrating an example of a structure of a first modified example of the second example embodiment of the invention.

FIG. 7 is a perspective view illustrating an example of a structure of a second modified example of the second example embodiment of the invention.

FIG. 8 is a perspective view illustrating an example of a structure of a third modified example of the second example embodiment of the invention.

FIG. 9 is a perspective view illustrating an example of a structure of a fourth modified example of the second example embodiment of the invention.

FIG. 10 is a perspective view illustrating an example of a structure of a fifth modified example of the second example embodiment of the invention.

FIG. 11 is a perspective view illustrating an example of a structure of an adaptor of a third example embodiment of the invention.

FIG. 12 is a perspective view illustrating an example of a structure of a receptacle which is integrally formed with a display lamp, and a plug.

FIG. 13 is a perspective view illustrating an example of a structure of a receptacle which is integrally formed with a display lamp, and a plug.

### EXAMPLE EMBODIMENT

Example embodiments of the invention are explained in detail below by referring to drawings. In all the drawings, equal structural elements have the same sign and explanations thereof are appropriately omitted.

### First Example Embodiment

A structure of the example embodiment is explained.

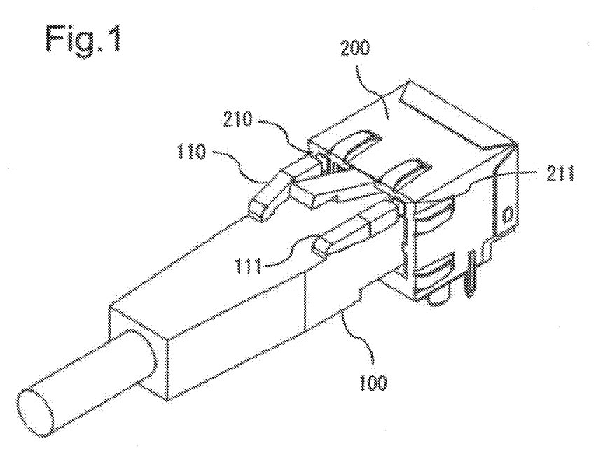

FIG. 1 is a perspective view illustrating an example of a structure of a plug of a first example embodiment of the invention. FIG. 1 illustrates a state that the plug is inserted to a receptacle.

Receptacle 200 includes one or more lamps (hereinafter referred to as “display lamp”) 210, etc. for displaying states. FIG. 1 illustrates an example that the receptacle includes two display lamps 210, 211. Receptacle 200 is integrally formed with display lamps 210, 211.

Display lamps 210, 211 display states, for example, of an interface using receptacle 200.

Being connected to receptacle 200, plug 100 can electrically connect to receptacle 200. Plug 100 is made of transparent or semitransparent resin, etc. Plug 100 includes light guide unit 110, etc. FIG. 1 illustrates an example that plug 100 includes two light guide units 110, 111.

Light guide units 110, 111 guide a light emitted from display lamps 210, 211 to the cable side of plug 100, which is a position that a user visually confirms with ease, respectively. Light guide units 110, 111 are pillar shaped, and are made of transparent resin, or the like. End faces of the light guide units 110, 111 are arranged at positions at which the lights emitted from light emission faces of display lamps 210, 211 are received, respectively. The other end faces of light guide units 110, 111 are connected to the cable side of plug 100. Light guide units 110, 111 are integrally formed with plug 100.

An operation in the example embodiment is explained.

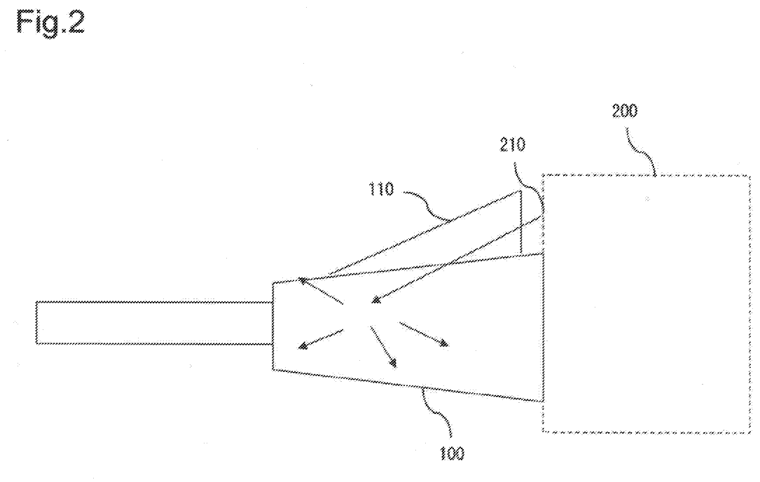

FIG. 2 is a diagram explaining an operation of the plug of the first example embodiment of the invention.

A light emitted from display lamp 210 arranged on receptacle 200 is guided to plug body 100 through light guide unit 110. The guided light emitted from display lamp 210 lights up a part of the cable side of plug 100.

As explained above, in plug 100 of the invention, a light emitted from display lamp 210, etc. is guided to plug 100. The light emitted from display lamp 210, etc. guided to plug 100 lights up plug 100. Plug 100 of the example embodiment has an effect that visibility of the display lamp when the plug is connected to the receptacle via a front face thereof on which the display lamp is formed is improved. Light may leak if a gap exists between light guide unit 110 and plug body 100. Therefore it is desirable that light guide unit 110 touches plug 100 without a gap therebetween.

In plug 100 of the example embodiment, visibility of a light emitting state of display lamp 210, etc. is improved without changing a device including receptacle 200. Plug 100 of the example embodiment has an effect that visibility of the light emitting state of the display lamp can be improved at low cost.

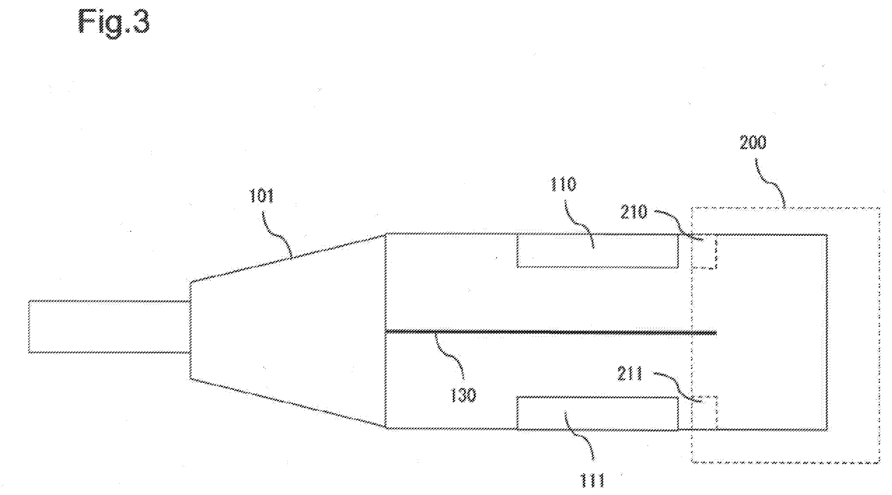

FIG. 3 is a top view of illustrating an example of a structure of a modified example of the first example embodiment of the invention. FIG. 3 illustrates a state that the plug is inserted to the receptacle.

Plug 101 of the modified example includes light separator 130 in a vertical direction along an axis of a direction to which plug 101 is inserted. Light separator 130 is made of a nontransparent plate shaped member. Light separator 130 is formed inside plug 101 or on a top face thereof.

In the above structure, lights emitted from the display lamps 210, 211 which are arranged on the left and the right on the front face of receptacle 200 is cut off by light separator 130 on the opposite side of the left and the right of plug 101. Each of the lights emitted from display lamp 210, 211 lights up only one side of the left or the right of plug 101.

Therefore, plug 101 of the modified example has an effect that lights emitted from display lamps 210, 211 can be distinguished.

### Second Example Embodiment

A second example embodiment of the invention is explained. In the example embodiment, a light guide unit guides an input light to a position or in a direction which is unlikely to be blocked by a plug connected to a receptacle or by a cable connected to the plug connected to the receptacle.

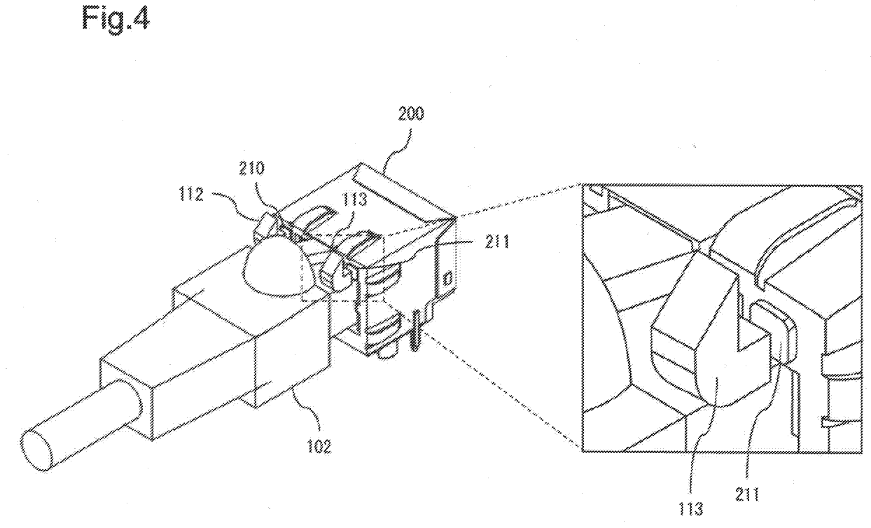

FIG. 4 is a perspective view illustrating an example of a structure of a plug of the second example embodiment of the invention. FIG. 4 illustrates a state that the plug is inserted to the receptacle.

In the example embodiment, end faces of light guide units 112, 113 of plug 102 face display lamps 210, 211, and receive lights emitted from display lamps 210, 211, respectively. Light guide unit 112, 113 are extended above plug 102. Each of the other end faces of the light guide units 112, 113 has a notch for outputting the emitted light obliquely upward on plug 102. In the example embodiment, the plug may not be transparent or semitransparent, but may be nontransparent.

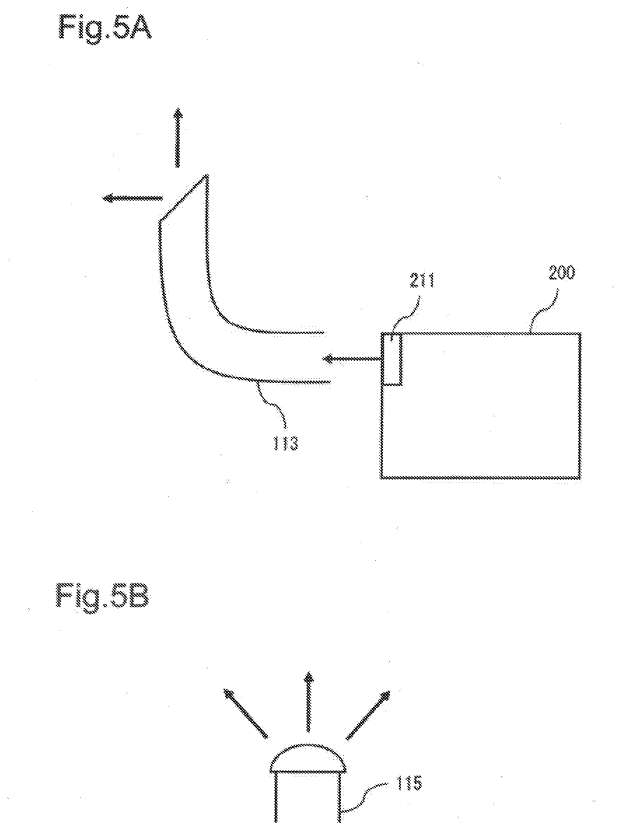

FIG. 5 is a diagram explaining operations of the plugs of the second example embodiment of the invention. As shown in FIG. 5(a), a light emitted from display lamp 211 enters light guide unit 113 from one side face thereof and is guided above plug 102. The guided light is outputted from the notch formed obliquely upward on the other end face of light guide unit 113 in a direction between a horizontal direction and an upward direction.

Plug 102 of the example embodiment has an effect that visibility of the light emitted from the display lamp in a direction between direction of a front face of the plug and an upward direction thereof is excellent.

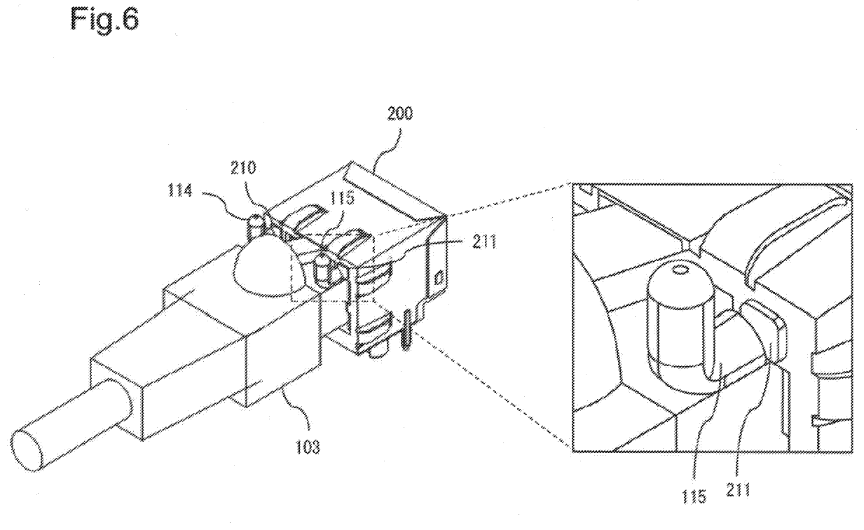

FIG. 6 is a perspective view illustrating an example of a structure of a first modified example of the second example embodiment of the invention. FIG. 6 illustrates a state that the plug is inserted to the receptacle.

In the modified example, end faces of light guide units 114, 115 of plug 103 face display lamps 210, 211, and receive the lights emitted from display lamps 210, 211, respectively. Light guide unit 114, 115 are extended above plug 102. Each of the other end faces of light guide units 114, 115 has a hemispherical shape.

In the structure, as shown in FIG. 5(b), a light emitted from display lamp 211 is outputted in all directions above plug 103.

Plug 103 of the modified example has an effect that visibility of a light emitted from the display lamp in a direction above the plug is excellent.

The light guide unit of the plug of the example embodiment may not be integrally formed with the plug, but may be a light guide component which is separately mounted on the plug body.

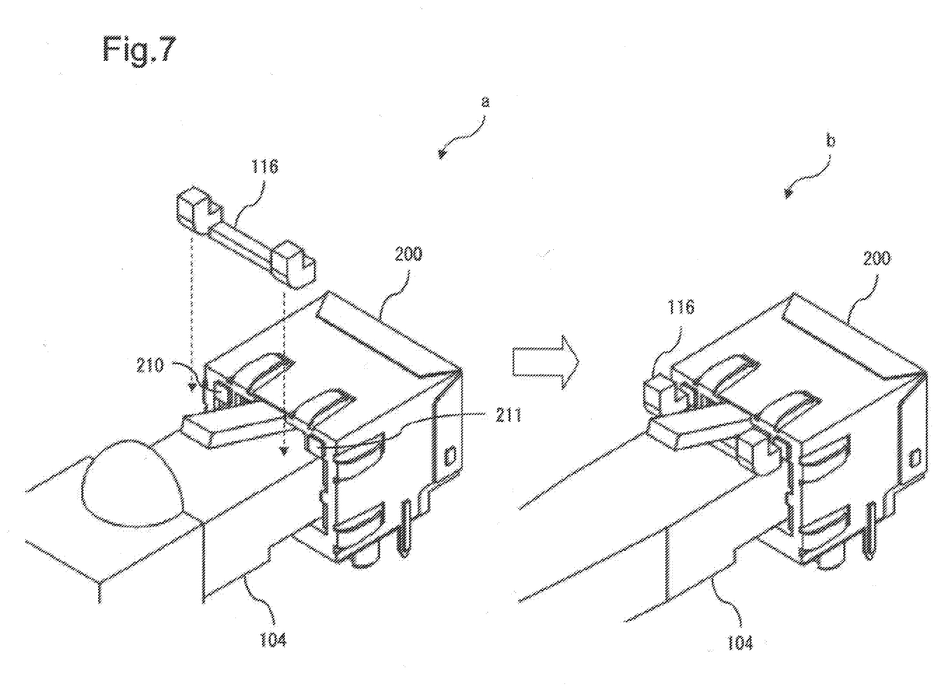

FIG. 7 is a perspective view illustrating an example of a structure of a second modified example of the second example embodiment of the invention. FIG. 7(a) illustrates a state that the light guide component is not mounted yet. FIG. 7(b) illustrates a state that the light guide component is mounted.

Light guide component 116 of the modified example is a light guide component which guides a light which is emitted toward the front face of receptacle 200 upward. Light guide component 116 is fixed on plug 104 having no light guide unit by using a double sided adhesive tape, glue, or the like.

In the structure, light guide component 116 of the modified example has an effect that it is possible to improve visibility of the display lamp of the receptacle by using a common plug. A plurality of shapes and sizes of light guide component 116 may be prepared in accordance with a kind of plug 104 and receptacle 200 and positions of display lamps 210, 211.

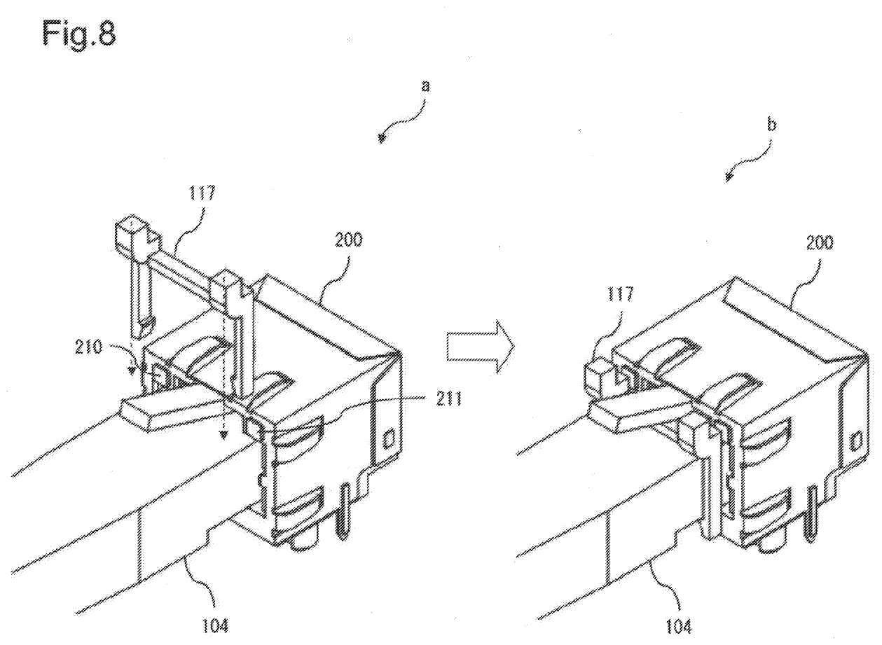

FIG. 8 is a perspective view illustrating an example of a structure of a third modified example of the second example embodiment of the invention. FIG. 8(a) illustrates a state that the light guide component is not mounted yet. FIG. 8(b) illustrates a state that the light guide component is mounted.

Light guide component 117 of the modified example includes a light guide unit which guides the light which is emitted toward the front face of receptacle 200 upward, and a connection unit for fixing the light guide unit on the tip of plug 104 by using hooks.

In the structure, light guide component 117 of the modified example has an effect that it is possible to improve visibility of the display lamp of the receptacle using a common plug, without using a double sided adhesive tape, glue, or the like.

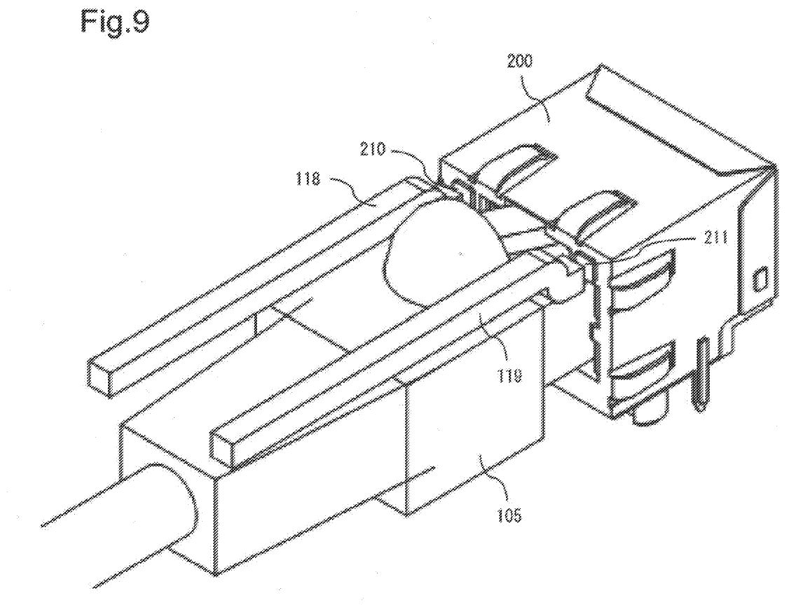

FIG. 9 is a perspective view illustrating an example of a structure of a fourth modified example of the second example embodiment of the invention. FIG. 9 illustrates a state after mounting on the receptacle.

Light guide units 118, 119 of plug 105 of the modified example are extended to an end part of plug 105 or near the end part of plug 105 in a direction which is perpendicular to the front face of receptacle 200 at a position which is translated along a front face of receptacle 200 above light emitting positions of display lamps 210, 211, respectively.

In the structure, positions of one ends of light guide units 118, 119 come closer to a user. Therefore, plug 105 of the modified example has an effect that visibility of light emission of the display lamps is improved even though the receptacle is arranged at an inner position of a device including the receptacle.

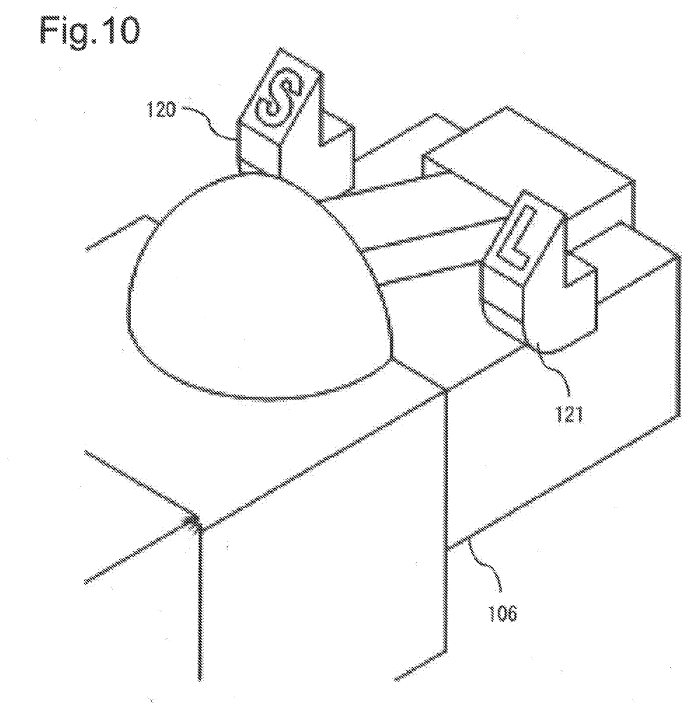

FIG. 10 is a perspective view illustrating an example of a structure of a fifth modified example of the second example embodiment of the invention. FIG. 10 illustrates a state that a receptacle is not mounted on a receptacle yet.

Letters, e.g. alphabet, or symbols are printed or punched on light emitting units of light guide units 120, 121 of plug 106 of the modified example. The letters or the symbols may represent, for example, meanings of the signal or arrangement order of the plugs.

In the structure, plug 106 of the modified example has an effect that meanings of the display lamp can be visually confirmed with ease.

### Third Example Embodiment

A third example embodiment on the basis of the second example embodiment of the invention is explained. In an adaptor of the example embodiment, the plug of the second example embodiment is connected and fixed to a different receptacle in a direction opposite to a direction of connection with a receptacle.

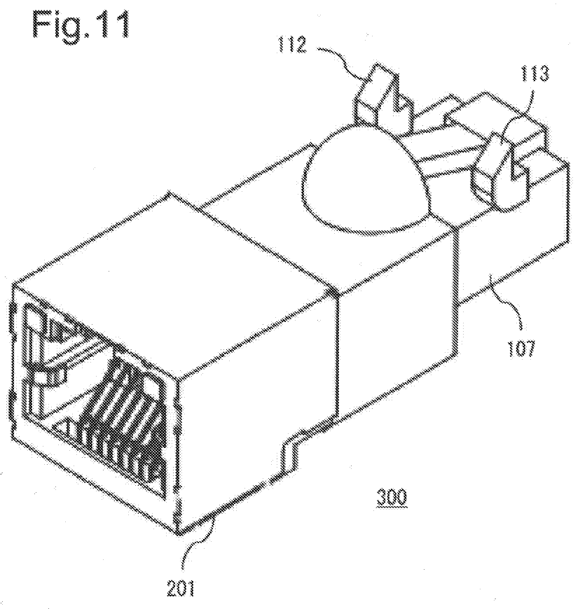

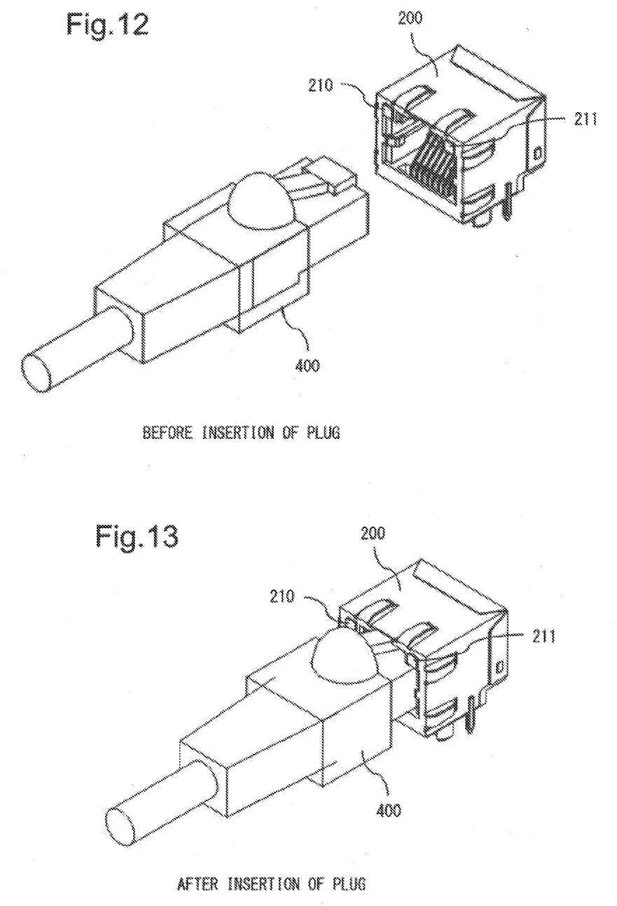

FIG. 11 is a perspective view illustrating an example of a structure of an adaptor of a third example embodiment of the invention.

Adaptor 300 of the example embodiment includes plug 107 and receptacle 201.

Plug 107 is the same as any one of the plugs in the second example embodiment.

Plug 107 is electrically connected to receptacle 201 in a direction opposite to a direction of the connection with a receptacle. Adaptor 300 extends a different receptacle to which plug 107 is connected by the length of adaptor 300, and relays a signal to the different receptacle to which plug 107 is connected.

As explained above, adaptor 300 of the example embodiment has the effect of the plug in the second example embodiment and an effect that an ordinary plug without a light guide unit can be connected to a receptacle via the adaptor.

While the invention has been particularly shown and described with reference to example embodiments and modified examples thereof, the invention is not limited to these embodiments and modified examples. It will be understood by those of ordinary skill in the art that various changes in form and details may be made therein without departing from the spirit and scope of the present invention as defined by the claims.

A part or all of the above example embodiments can be described as the following supplementary notes, but are not limited to the following.

### (Supplementary Note 1)

A plug for connection with a receptacle via a front face thereof on which a display lamp is formed, comprising
a light guide unit inputting a light from the display lamp, guiding the input light to a position or in a direction that is unlikely to be blocked by the plug connected to the receptacle or by a cable connected to the plug connected to the receptacle, and outputting the guided light from the other end.

### (Supplementary Note 2)

The plug according to supplementary note 1, wherein the position or the direction that is unlikely to be blocked is a position to which a light emitting position of the display lamp is translated along the front face of the receptacle

### (Supplementary Note 3)

The plug according to supplementary note 1, wherein the position or the direction that is unlikely to be blocked is a direction that differs from a light emitting direction of the display lamp.

### (Supplementary Note 4)

The plug according to supplementary note 3, wherein the other end of the light guide unit is notched shaped or is hemisphere shaped.

### (Supplementary Note 5)

The plug according to any one of supplementary notes 1 to 4, wherein the plug is transparent or semitransparent, and the input light is guided from the light guide unit into the plug.

### (Supplementary Note 6)

The plug according to any one of supplementary notes 1 to 5, wherein in case that a plurality of the light guide units are arranged, a light separator is arranged on the plug or in the plug between the plurality of light guide units.

### (Supplementary Note 7)

The plug according to any one of supplementary notes 1 to 6, wherein a position of the other end of the light guide unit is arranged on an end of the plug or near the end thereof.

### (Supplementary Note 8)

The plug according to any one of supplementary notes 1 to 7, wherein a letter or a symbol is given on the other end of the light guide unit.

### (Supplementary Note 9)

A light guide component that is mounted on a plug for connection with a receptacle via a front face thereof on which a display lamp is formed, wherein the light guide component inputs a light from the display lamp, guides the input light is guided to a position or in a direction that is unlikely to be blocked by the plug connected to the receptacle or by a cable connected to the plug connected to the receptacle, and outputs the guided light from the other end.

### (Supplementary Note 10)

The light guide component according to supplementary note 9, wherein the position or the direction that is unlikely to be blocked is a position to which a light emitting position of the display lamp is translated along the front face of the receptacle

### (Supplementary Note 11)

The light guide component according to supplementary note 9, wherein the position or the direction that is unlikely to be blocked is a direction that differs from a light emitting direction of the display lamp.

### (Supplementary Note 12)

An adapter comprising:
a plug for connection with a first receptacle via a front face thereof on which a display lamp is formed; and
a second receptacle electrically connected to the plug in a direction opposite to a direction of the connection with the first receptacle, wherein
the plug includes a light guide unit inputting a light from the display lamp, guiding the input light to a position or in a direction that is unlikely to be blocked by the plug connected to the first receptacle or by a cable connected to the plug connected to the first receptacle, and outputting the guided light from the other end.

### (Supplementary Note 13)

The adapter according to supplementary note 12, wherein the position or the direction that is unlikely to be blocked is a position to which a light emitting position of the display lamp is translated along the front face of the receptacle

### (Supplementary Note 14)

The adapter according to supplementary note 12, wherein the position or the direction that is unlikely to be blocked is a direction that differs from a light emitting direction of the display lamp.

This application is based upon and claims the benefit of priority from Japanese Patent Application No. 2016-198130, filed on Oct. 6, 2016, the disclosure of which is incorporated herein in its entirety by reference.

### INDUSTRIAL APPLICABILITY

The invention is applicable to improvement of visibility of a display lamp in a device including a receptacle which is integrally formed with the display lamp.

### REFERENCE SIGNS LIST

100, 101, 102, 103, 104, 105, 106, 107 plug
110, 111, 112, 113, 114, 115, 118, 119 light guide unit
116, 117 light guide component
120, 121 light guide unit
130 light separator
200, 201 receptacle
210, 211 display lamp
300 adaptor
400 plug

What is claimed is:

1. A plug for connection with a receptacle via a front face thereof on which a display lamp is formed, comprising
a light guide unit inputting a light from the display lamp, guiding the input light to a position or in a direction that is unlikely to be blocked by the plug connected to the receptacle or by a cable connected to the plug connected to the receptacle, and outputting the guided light from the other end.

2. The plug according to claim 1, wherein the position or the direction that is unlikely to be blocked is a position to which a light emitting position of the display lamp is translated along the front face of the receptacle

3. The plug according to claim 1, wherein the position or the direction that is unlikely to be blocked is a direction that differs from a light emitting direction of the display lamp.

4. The plug according to claim 3, wherein the other end of the light guide unit is notched shaped or is hemisphere shaped.

5. The plug according to claim 1, wherein the plug is transparent or semitransparent, and the input light is guided from the light guide unit into the plug.

6. The plug according to claim 1, wherein in case that a plurality of the light guide units are arranged, a light separator is arranged on the plug or in the plug between the plurality of light guide units.

7. The plug according to claim 1, wherein a position of the other end of the light guide unit is arranged on an end of the plug or near the end thereof.

8. The plug according to claim 1, wherein a letter or a symbol is given on the other end of the light guide unit.

9. A light guide component that is mounted on a plug for connection with a receptacle via a front face thereof on which a display lamp is formed, wherein the light guide component inputs a light from the display lamp, guides the input light is guided to a position or in a direction that is unlikely to be blocked by the plug connected to the receptacle or by a cable connected to the plug connected to the receptacle, and outputs the guided light from the other end.

10. An adapter comprising:
a plug for connection with a first receptacle via a front face thereof on which a display lamp is formed; and
a second receptacle electrically connected to the plug in a direction opposite to a direction of the connection with the first receptacle, wherein
the plug includes a light guide unit inputting a light from the display lamp, guiding the input light to a position or in a direction that is unlikely to be blocked by the plug connected to the first receptacle or by a cable connected to the plug connected to the first receptacle, and outputting the guided light from the other end.

11. The light guide component according to claim 9, wherein the position or the direction that is unlikely to be blocked is a position to which a light emitting position of the display lamp is translated along the front face of the receptacle.

12. The light guide component according to claim 9, wherein the position or the direction that is unlikely to be blocked is a direction that differs from a light emitting direction of the display lamp.

13. The adapter according to claim 10, wherein the position or the direction that is unlikely to be blocked is a position to which a light emitting position of the display lamp is translated along the front face of the first receptacle.

14. The adapter according to claim 10, wherein the position or the direction that is unlikely to be blocked is a direction that differs from a light emitting direction of the display lamp.

15. The plug according to claim 2, wherein the plug is transparent or semitransparent, and the input light is guided from the light guide unit into the plug.

16. The plug according to claim 3, wherein the plug is transparent or semitransparent, and the input light is guided from the light guide unit into the plug.

17. The plug according to claim 4, wherein the plug is transparent or semitransparent, and the input light is guided from the light guide unit into the plug.

18. The plug according to claim 2, wherein in case that a plurality of the light guide units are arranged, a light separator is arranged on the plug or in the plug between the plurality of light guide units.

19. The plug according to claim 3, wherein in case that a plurality of the light guide units are arranged, a light separator is arranged on the plug or in the plug between the plurality of light guide units.

20. The plug according to claim 4, wherein in case that a plurality of the light guide units are arranged, a light separator is arranged on the plug or in the plug between the plurality of light guide units.
